(19) United States
(12) Patent Application Publication
(10) Pub. No.: US 2021/0059141 A1
(43) Pub. Date: Mar. 4, 2021

(54) CULTIVATION PANEL AND METHOD FOR CULTIVATING PLANT

(71) Applicant: Showa Denko K.K., Tokyo (JP)

(72) Inventor: Hiroshi Suzuki, Tokyo (JP)

(73) Assignee: Showa Denko K.K., Tokyo (JP)

(21) Appl. No.: 16/945,986

(22) Filed: Aug. 3, 2020

(30) Foreign Application Priority Data
Aug. 27, 2019 (JP) 2019-154931

(51) Int. Cl. A01G 31/06

(52) U.S. Cl. CPC A01G 31/06

(57) ABSTRACT

A cultivation panel includes: a first hole group constituted by a first hole row having plural holes arranged in line in one direction and a second hole row provided at a position away from the first hole row in another direction intersecting the one direction, the second hole row having plural holes arranged in line in the one direction; and a third hole row having plural holes arranged in line in the one direction, a first distance between one hole among the plural holes in the third hole row and one hole included in the holes in the second hole row of the first hole group being larger than a second distance between adjacent holes in the second hole row.

### CROSS REFERENCE TO RELATED APPLICATIONS

This application is based on and claims priority under 35 USC § 119 from Japanese Patent Application No. 2019-154931 filed Aug. 27, 2019.

### BACKGROUND

### Technical Field

The present invention relates to a cultivation panel and a method for cultivating a plant.

### Related Art

In recent years, in a plant factory, hydroponic cultivation that grows plants by a solution dissolving nutrients required for growth (nutrient solution) without using a soil has been adopted. In hydroponic cultivation, a hydroponic panel for holding plants at intervals is used. For example, a hydroponic panel described in Japanese Patent Application Laid-Open Publication No. 2012-165680 has plural through holes formed at predetermined intervals in a quadrangular panel main body made of a foam resin.

In the case where plural through holes are formed at regular intervals in a cultivation panel used in hydroponic cultivation, there is a possibility that plural plants cultivated by the cultivation panel do not grow to a uniform size. For example, a size of a plant cultivated in a through hole surrounded by another plant possibly be smaller than a size of a plant not surrounded by another plant.

An object of the present invention is to provide a cultivation panel and the like capable of not causing variation in sizes of plants.

### SUMMARY

The present invention completed under such an object provides a cultivation panel including: a panel main body including: a first hole group constituted by a first hole row having plural holes arranged in line in a first direction and a second hole row provided at a position away from the first hole row in a second direction intersecting the first direction, the second hole row having plural holes arranged in line in the first direction; and a third hole row having plural holes arranged in line in the first direction, a first distance between one hole among the plural holes in the third hole row and one hole among the plural holes in the second hole row of the first hole group being larger than a second distance between adjacent holes in the second hole row.

Here, positions of the holes in the first hole row and positions of the holes in the second hole row may not overlap each other in the first direction.

Moreover, two adjacent holes in one of the first hole row and the second hole row and one hole in the other one of the first hole row and the second hole row may be disposed to serve as respective vertexes of an equilateral triangle.

Moreover, the first hole row, the second hole row and the third hole row may be arranged in this order in the second direction, and positions of the holes in the second hole row and positions of the holes in the third hole row may not overlap each other in the first direction.

Moreover, two adjacent holes in the second hole row and one hole in the third hole row may be disposed to serve as respective vertexes of an isosceles triangle.

Moreover, the cultivation panel may be in a shape of a rectangle when viewed in a centerline direction of each of the plural holes, and the first direction may be a longitudinal direction of the rectangle and the second direction may be a short direction of the rectangle.

Moreover, a cultivation panel according to the present invention may include: a panel main body including: a first hole group constituted by a first hole row having plural holes arranged in line in a first direction and a second hole row provided at a position away from the first hole row in a second direction intersecting the first direction, the second hole row having plural holes arranged in line in the first direction; and a second hole group constituted by a third hole row having plural holes arranged in line in the first direction and a fourth hole row provided at a position away from the third hole row in the second direction, the fourth hole row having plural holes arranged in line in the first direction, wherein the first hole group and the second hole group may be separated in the second direction to make a distance between a hole included in the second hole row of the first hole group and a hole included in the third hole row of the second hole group larger than a distance between adjacent holes in the second hole row of the first hole group.

Moreover, from another standpoint, the present invention provides a method for cultivating a plant, the method including: installing a cultivation panel comprising a panel main body including: a first hole group constituted by a first hole row having plural holes arranged in line in a first direction and a second hole row provided at a position away from the first hole row in a second direction intersecting the first direction, the second hole row having plural holes arranged in line in the first direction; and a third hole row having plural holes arranged in line in the first direction, a first distance between one hole among the plural holes in the third hole row and one hole among the plural holes in the second hole row of the first hole group being larger than a second distance between adjacent holes in the second hole row; and setting a plant in each of the holes formed in the cultivation panel.

Here, in installing the cultivation panel, the cultivation panel may be installed in a plant cultivation device provided in a closed plant factory, and, in setting the plant, a leaf lettuce may be set in each of the holes formed in the cultivation panel.

According to the present invention, it is possible to provide a cultivation panel capable of not causing variation in sizes of plants.

### BRIEF DESCRIPTION OF THE DRAWINGS

FIG. 1 is a diagram showing an example of a schematic configuration of a cultivation panel related to a first exemplary embodiment;

FIG. 2 is a plan view of the cultivation panel related to the first exemplary embodiment;

FIG. 3A shows a plan view of a cultivation panel related to a comparative example;

FIG. 3B is a diagram showing weights of lettuces after growing the lettuces in all through holes in the panel related to the comparative example for a predetermined period of time in the same environment;

FIG. 4A is a diagram showing rows in which the lettuces have been grown and rows in which no lettuce has been grown using the panel related to the comparative example;

FIG. 4B is a diagram showing weights of the lettuces after growing the lettuces in the rows in which the lettuces have been grown shown in FIG. 3A for a predetermined period of time in the same environment;

FIG. 5 is a plan view of a cultivation panel related to a second exemplary embodiment;

FIG. 6 is a plan view of a cultivation panel related to a third exemplary embodiment; and

FIG. 7 is a diagram showing an example of a schematic configuration of a plant cultivation device, the device being viewed from the front.

### DETAILED DESCRIPTION

Hereinafter, exemplary embodiments according to the present invention will be described in detail with reference to attached drawings.

### First Exemplary Embodiment

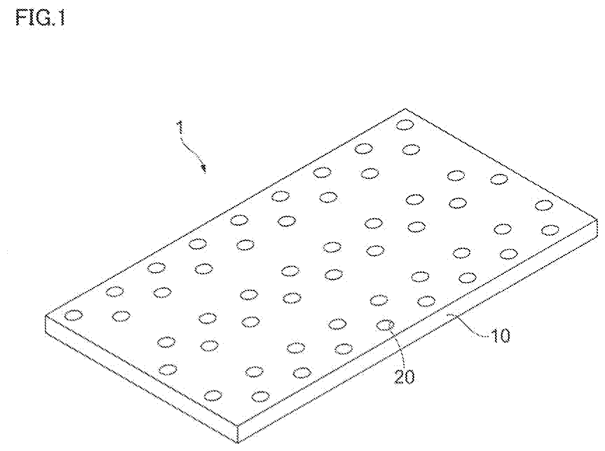

FIG. 1 is a diagram showing an example of a schematic configuration of a cultivation panel 1 related to a first exemplary embodiment.

The cultivation panel 1 related to the first exemplary embodiment is a panel main body 10 in a rectangular-parallelepiped shape in which plural through holes 20 in the cylindrical shape are formed. The cultivation panel 1 is used for hydroponic cultivation of, for example, leaf vegetables, fruit vegetables, root vegetables, fruit trees, grains, liverworts, ferns, foliage plants, medicinal herbs, and the like.

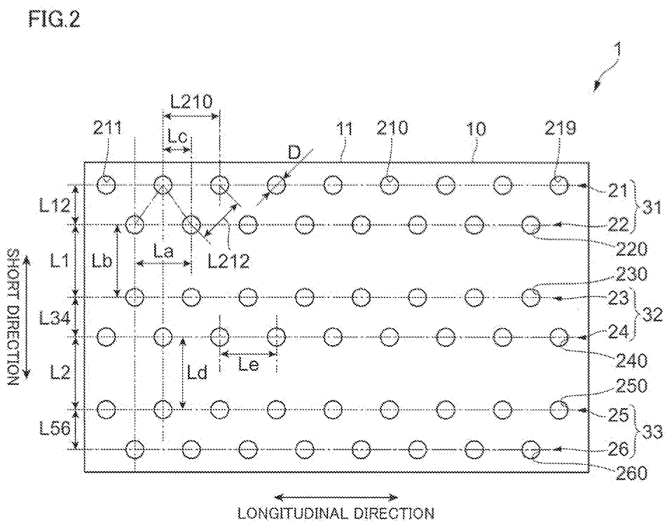

FIG. 2 is a plan view of the cultivation panel 1 related to the first exemplary embodiment. FIG. 2 is also a diagram viewing the cultivation panel 1 in the centerline direction of the through holes 20.

As shown in FIG. 2, the panel main body 10 has a rectangular shape in which, in planar configuration, the width direction in FIG. 2 is the longitudinal direction and the lengthwise direction in FIG. 2 is the short direction. Moreover, the panel main body 10 is in a flat plate shape in which the sizes in the longitudinal direction and the short direction are larger than the size in the vertical direction (the direction orthogonal to the page of FIG. 2). For example, in the panel main body 10, the size in the longitudinal direction is 125 cm, the size in the short direction is 81 cm, and the size in the vertical direction is 10 cm. Examples of the material of the panel main body 10 can include a foam resin, such as foamed polystyrene, foamed polyethylene, or foamed polypropylene.

The through hole 20 penetrates through the panel main body 10 in the vertical direction. All of the plural through holes 20 have the same pore diameter D.

The plural through holes 20 include a first hole group 31 constituted by a first hole row 21 in which plural through holes 210 are arranged in line in the longitudinal direction and a second hole row 22 provided at a position of a distance L12 in the short direction from the first hole row 21, in which plural through holes 220 are arranged in line in the longitudinal direction.

Moreover, the plural through holes 20 include a second hole group 32 constituted by a third hole row 23 in which plural through holes 230 are arranged in line in the longitudinal direction and a fourth hole row 24 provided at a position of a distance L34 in the short direction from the third hole row 23, in which plural through holes 240 are arranged in line in the longitudinal direction.

Further, the plural through holes 20 include a third hole group 33 constituted by a fifth hole row 25 in which plural through holes 250 are arranged in line in the longitudinal direction and a sixth hole row 26 provided at a position of a distance L56 in the short direction from the fifth hole row 25, in which plural through holes 260 are arranged in line in the longitudinal direction.

Note that the distances L12, L34 and L56 are the distance between the centers of the through holes 20. The distances L12, L34 and L56 are set to be equal.

Moreover, the first hole group 31 and the second hole group 32 are provided at positions of the distance L1 from each other in the short direction. The distance L1 is a distance in the short direction between the centers of the holes in the second hole row 22 at a closer position, in the first hole group 31, to the second hole group 32 and the centers of the corresponding holes in the third hole row 23 at a closer position, in the second hole group 32, to the first hole group 31.

Moreover, the second hole group 32 and the third hole group 33 are provided at positions of the distance L2 from each other in the short direction. The distance L2 is a distance in the short direction between the centers of the holes in the fourth hole row 24 at a closer position, in the second hole group 32, to the third hole group 33 and the centers of the corresponding holes in the fifth hole row 25 at a closer position, in the third hole group 33, to the second hole group 32.

Note that the distances L1 and L2 are set to be equal.

In the plan view of FIG. 2, the first hole row 21 is formed at a position closer to a first long side 11, which is one of long sides of the rectangular-shaped panel main body 10. Each of the through holes 211 and 219 that are the through holes 210 at both ends of the first hole row 21 is formed near a vertex of the rectangular-shaped panel main body 10. Then, the seven through holes 210 in the first hole row 21 are arranged in line at regular intervals between the through holes 211 and 219.

The second hole row 22 includes eight through holes 220 arranged in line at regular intervals. Each through hole 220 in the second hole row 22 is formed so that the position thereof in the longitudinal direction does not overlap the position of the through hole 210 in the first hole row 21. In other words, the holes are set so that the distance Lc between the centers of the through holes 210 in the first hole row 21 and the centers of the through holes 220 in the second hole row 22 is larger than the hole diameter D of the through hole 20. Moreover, in the longitudinal direction, the holes are set so that each through hole 220 in the second hole row 22 is provided at the center between two through holes 210 in the first hole row 21. That is to say, two through holes 210 and one through hole 220 are disposed to form an isosceles triangle.

Further, the distance L210 between the two through holes 210 and the distance L212 between the through hole 210 and the through hole 220 are set to be equal. In other words, the two through holes 210 and the one through hole 220 are disposed to form an equilateral triangle. Therefore, all of the plural through holes 210 and 220 in the first hole group 31 are disposed at regular intervals.

The third hole row 23 includes eight through holes 230 arranged in line at regular intervals. A distance Lb between the through hole 230 in the third hole row 23 and the through hole 220, which is also the through hole 20 in the first hole group 31, at the position nearest to the through hole 230 is set larger than a distance La between the adjacent through holes (between the through holes 220 and between the through holes 210 and 220) among the plural through holes 20 included in the first hole group 31 (Lb>La).

In the cultivation panel 1 related to the first exemplary embodiment, the positions of the through holes 230 in the third hole row 23 in the longitudinal direction and the positions of the through holes 220 in the second hole row 22 in the longitudinal direction are set to be the same. Therefore, the distance L1 and the distance Lb are equal.

The fourth hole row 24 includes nine through holes 240 arranged in line at regular intervals. In addition, the positions of the through holes 240 in the fourth hole row 24 in the longitudinal direction and the positions of the through holes 210 in the first hole row 21 in the longitudinal direction are set to be the same. Further, the distance between the two through holes 240 and the distance between the through hole 240 and the through hole 230 are set to be equal. In other words, all of the plural through holes 20 in the second hole group 32 are disposed at regular intervals. Moreover, the second hole group 32 and the first hole group 31 are in a symmetrical shape.

The third hole group 33 is in a same shape with the first hole group 31 and is in a symmetrical shape with the second hole group 32. The distance Ld between the through hole 250 in the fifth hole row 25 and the through hole 240, which is also the through hole 20 in the second hole group 32, at the position nearest to the through hole 250 is set larger than the distance Le between the adjacent through holes (between the through holes 240 and between the through holes 230 and 240) among the plural through holes 20 included in the second hole group 32 (Ld>Le).

In the cultivation panel 1 related to the first exemplary embodiment, the positions of the through holes 250 in the fifth hole row 25 in the longitudinal direction and the positions of the through holes 240 in the fourth hole row 24 in the longitudinal direction are the same; therefore, the distance L2 and the distance Ld are equal.

In addition, as described above, since the distance L1 and the distance L2 are equal, the distance Lb and the distance Ld are equal. Moreover, the distance La and the distance Le are equal.

The above-described configuration of the cultivation panel 1 related to the first exemplary embodiment is due to the knowledge, which the present inventors have obtained, that, in the case where plants are cultivated in all through holes in a cultivation panel in which plural through holes are formed at regular intervals, some plants do not grow uniformly in size.

Hereinafter, description will be given more specifically.

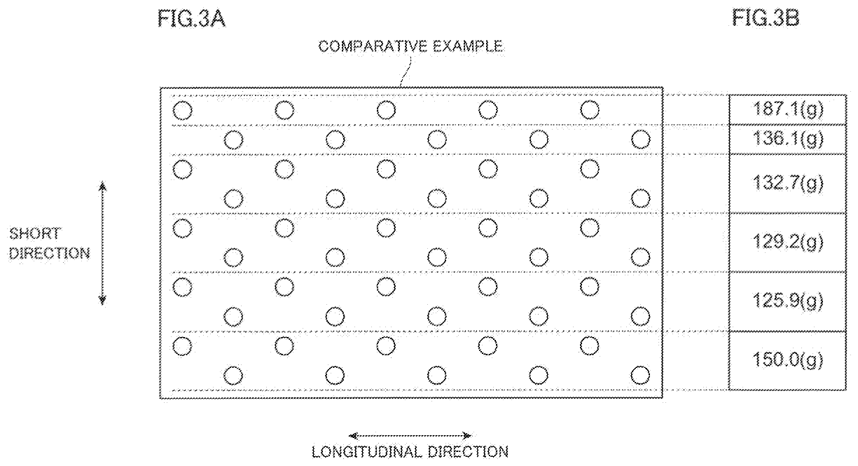

FIG. 3A shows a plan view of a cultivation panel related to a comparative example (hereinafter, referred to as “the panel related to the comparative example” in some cases).

In the panel related to the comparative example, plural through holes are formed at regular intervals. In other words, the panel related to the comparative example includes 10 rows each having five through holes arranged in line in the longitudinal direction, and the position of each through hole of one of the rows in the longitudinal direction is positioned at the center between the through holes in an adjacent row. Then, the distances between one through hole among the five through holes in the one row and through holes, which are adjacent to the one through hole, in two other rows adjacent to the one row are equal.

FIG. 3B is a diagram showing weights of lettuces after growing the lettuces in all through holes in the panel related to the comparative example for a predetermined period of time in the same environment.

As shown in FIG. 3B, the average value of weights of five lettuces grown in the first highest row in FIG. 3B was 187.1 (g). Moreover, the average value of weights of five lettuces grown in the second highest row was 136.1 (g). The average value of weights of ten lettuces grown in the third and fourth highest rows was 132.7 (g). The average value of weights of ten lettuces grown in the fifth and sixth highest rows was 129.2 (g). The average value of weights of ten lettuces grown in the seventh and eighth highest rows was 125.9 (g). The average value of weights of ten lettuces grown in the ninth and tenth highest rows was 150.0 (g).

From the results shown in FIG. 3B, it can be learned that the average value of weights of the lettuces grown in the first row is the heaviest, and thereby grown to be the largest. On the other hand, the average value of weights of the lettuces grown in the third to eighth rows is about 70 percent of the average value of weights of the lettuces grown in the first row. From these, the present inventors have known that the lettuces grown in the first row grew large because there were no lettuce above them in FIG. 3B, whereas the lettuces grew in the third to eighth rows did not grow as large as the lettuces in the first row because each of them, except for the lettuces on the end portions in the longitudinal direction, was surrounded by six lettuces.

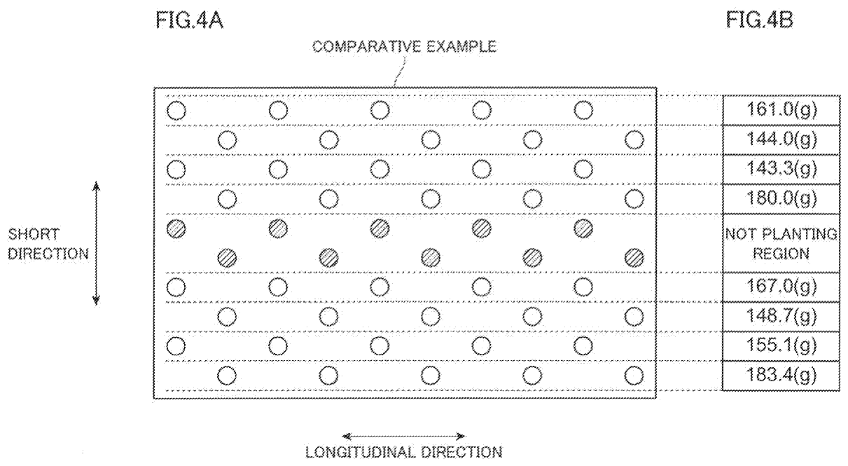

FIG. 4A is a diagram showing rows in which the lettuces have been grown and rows in which no lettuce has been grown using the panel related to the comparative example.

FIG. 4B is a diagram showing weights of the lettuces after growing the lettuces in the rows in which the lettuces have been grown shown in FIG. 4A for a predetermined period of time in the same environment. Note that the predetermined period of time in the results shown in FIG. 4B and the predetermined period of time in the results shown in FIG. 4A are the same.

As shown in FIG. 4A, no lettuce was planted in the fifth and sixth highest rows in the panel related to the comparative example, and, only in the rest of the rows, namely, in the first to fourth and the seventh to tenth highest rows, the lettuces were planted and grown. Therefore, the distance between the lettuces in the fourth row and the lettuces in the seventh row is, at the shortest, larger than the distance between the adjacent through holes.

As a result, as shown in FIG. 4B, the average value of weights of five lettuces grown in the first highest row was 161.0 (g). Moreover, the average value of weights of five lettuces grown in the second highest row was 144.0 (g). Moreover, the average value of weights of five lettuces grown in the third highest row was 143.3 (g). Moreover, the average value of weights of five lettuces grown in the fourth highest row was 180.0 (g). The average value of weights of five lettuces grown in the seventh highest row was 167.0 (g). Moreover, the average value of weights of five lettuces grown in the eighth highest row was 148.7 (g). Moreover, the average value of weights of five lettuces grown in the ninth highest row was 155.1 (g). Moreover, the average value of weights of five lettuces grown in the tenth highest row was 183.4 (g). In addition, a standard deviation of weights of the lettuces in the results shown in FIG. 4B was about 31%.

From the results shown in FIG. 4B, the average value of weights of the lettuces grown in the tenth row is the heaviest, and the average value of weights of the lettuces grown in the fourth row is the second heaviest. The third heaviest is the average value of weights of the lettuces grown in the seventh row, and the fourth heaviest is the average value of weights of the lettuces grown in the first row. It can be learned that, since there is no other lettuce above the lettuces in the first row and there is no other lettuce below the lettuces in the tenth row, the lettuces in these rows have grown large. Moreover, it can be learned that, since the distance in the short direction between the through holes in which the lettuces were grown in the fourth row and the through holes in which the lettuces were grown in the seventh row is larger than the distance between the adjacent through holes, the lettuces in these rows have grown large.

In addition, from the results shown in FIG. 4B, it can be learned that the lettuces in the second, third, eighth and ninth rows did not grow as large as the lettuces in the first, fourth, seventh and tenth rows.

From the above, the present inventors have known that the lettuces have grown large in the case where there was no other lettuce above or below, or in the case where the distance between the through holes in which the lettuces were grown, the through holes being in the different rows, was larger than the distance between the adjacent through holes in the same row. In addition, the present inventors have known that the lettuces in the second, third, eighth and ninth rows did not grow as large as the lettuces in the first, fourth, seventh and tenth rows because each of them, except for the lettuces on the end portions in the longitudinal direction, was surrounded by five lettuces.

The reason of the above-described matter is considered that, in the case where there are less plants around the plants that are planted in the through holes to be grown, the plants do not mutually shield light or air currents; therefore, the plants get sufficient light and wind paths are secured. If air movement around the leaves of the plants is rare, ability to exhale moisture from stomata in the leaves is reduced, and thereby transpiration action is suppressed. As a result, ability to draw up water at the roots is reduced and nutrients are not provided to tip ends of the leaves. If the nutrients are not provided to the tip ends of the leaves, there is a possibility of occurrence of tipburn in which the tip ends of the leaves wither and turn to brown. In contrast thereto, secured wind (air currents) paths make it possible to provide nutrients to the tip ends of the leaves, and make it easier to grow the plants. Moreover, the secured air currents rarely cause troubles, such as the tipburn. In particular, in the case of a breed having characteristics of easily spreading transversally in the direction orthogonal to the through hole direction, like leaf lettuce, the plants do not mutually shield light or air currents when one of the plants are not surrounded by the other plants, and thereby the plants are likely to grow larger.

Based on the above knowledge, in the cultivation panel 1 related to the first exemplary embodiment, each hole group (the first hole group 31, the second hole group 32 and the third hole group 33) is constituted by two hole rows, and the distance Lb in the short direction between the adjacent hole groups (between the first hole group 31 and the second hole group 32, and between the second hole group 32 and the third hole group 33) is set larger than the distance La between the adjacent through holes 20 in each hole row in each hole group.

For example, the cultivation panel 1 includes the first hole group 31 constituted by the first hole row 21 in which the plural through holes 210 are arranged in line in the longitudinal direction, as an example of a first direction, and the second hole row 22 provided at a position away in the short direction, as an example of a second direction intersecting the longitudinal direction, from the first hole row 21, in which the plural through holes 220 are arranged in line in the longitudinal direction. Moreover, the cultivation panel 1 includes the third hole row 23 that is formed so that the distance Lb between one through hole 230 among the plural through holes 230 arranged in line in the longitudinal direction and the through holes 220 included in the second hole row 22 of the first hole group 31 is larger than the distance La between the adjacent through holes 220 in the second hole row 22.

In the cultivation panel 1 configured as described above, the first hole row 21 and the sixth hole row 26 are not provided with through holes 20 formed above and below, respectively. Moreover, the distance Lb between the through holes 20 in the second hole row 22, the third hole row 23, the fourth hole row 24 and the fifth hole row 25 and the through holes 20 in the facing hole group is larger than the distance between the adjacent through holes 20 in the same row. Therefore, the plants in all of the through holes can get light well and the wind paths are secured particularly in the longitudinal direction; accordingly, the plants are likely to grow larger. In particular, in the case of the breed having characteristics of easily spreading transversally, like leaf lettuce, the plants do not mutually shield light or air currents, and thereby the plants are likely to grow larger.

In addition, except for the through holes 20 on the end portions in the longitudinal direction, the through holes 220, 230, 240 and 250 of the second hole row 22, the third hole row 23, the fourth hole row 24 and the fifth hole row 25, respectively, have the same conditions about the distance with the surrounding through holes 20. In other words, there are surrounding four through holes 20 belonging to the same hole group at the same distance La, and the distance Lb with the through hole 20 belonging to the facing hole group is larger than the distance La. Therefore, these through holes 20 can similarly get light and the wind paths are likely to be secured.

Moreover, the through holes 210 in the first hole row 21 or the through holes 260 in the sixth hole row 26 are different in the point that there are no other through holes 20 above or below, respectively; however, the above-described condition that the through hole 220, 230, 240 or 250 has four through holes 20 belonging to the same hole group at the positions of the same distance La holds true.

From above, according to the cultivation panel 1, even though plants are grown in all of the plural through holes 20, it is possible to eliminate variations to be caused in size of the plants. In other words, according to the cultivation panel 1, adverse effects, such as getting less light, difficulties in securing the wind paths and the like, caused by mutual shielding are reduced, and therefore, variations in the harvested head weight are also reduced. In actuality, the standard deviation in the weights of the lettuces when the lettuces were cultivated in all of the plural through holes 20 by use of the cultivation panel 1 was about 26%. This is a lower value than the standard deviation in the weights of the lettuces in the results shown in FIG. 4B, which is about 31%. In addition, in the case where the cultivation panel 1 was used, tipburn was not observed. In the case where the panel related to the comparative example was used, a minor degree of tipburn was observed.

Moreover, in the cultivation panel 1, each hole group is constituted by two hole rows and the distance between the adjacent hole groups in the short direction is set larger than the distance between the adjacent through holes in each hole group; thereby it is possible to reduce the distance between the through holes 20 belonging to the same hole row. With this, as described above, it becomes possible to dispose three through holes 20 among the plural through holes 20 belonging to each hole group to form an equilateral triangle. Moreover, since the through holes 20 are disposed to form the equilateral triangle, it is possible to reduce the distance in the short direction in each hole group. Therefore, for example, as compared to the case in which the through holes 20 in two hole rows belonging to each hole group are disposed at the same positions in the longitudinal direction and the distance between the through hole 20 in one of the two hole rows and the through hole 20 in the other one of the two hole rows is set at the same distance of the cultivation panel 1, the distance between the two hole rows in the short direction can be 3^{1/2}/2.

From above, even though the size of the panel main body 10 of the cultivation panel 1 and the size of the panel main body of the panel related to the comparative example are the same, substantially the same number of through holes 20 can be formed (51 in the cultivation panel 1 and 50 in the panel related to the comparative example). Therefore, even when the cultivation panel 1 is used, productivity similar to that in the use of the panel related to the comparative example can be secured. In other words, according to the cultivation panel 1, arrangement of the through holes 20, and by extension, arrangement of the plants (heads) to be cultivated can differ from the panel related to the comparative example to allow the plants to get more light and to secure the wind (air currents) paths in the longitudinal direction without reducing productivity; therefore, it is possible not to cause variations in the size of the plants.

Note that the above-described cultivation panel 1 is a panel main body 10 in the rectangular-parallelepiped shape having the plural through holes 20 formed thereon; however, the panel is not limited to such a mode. For example, the cultivation panel 1 may be constituted by combining plural parts.

### Second Exemplary Embodiment

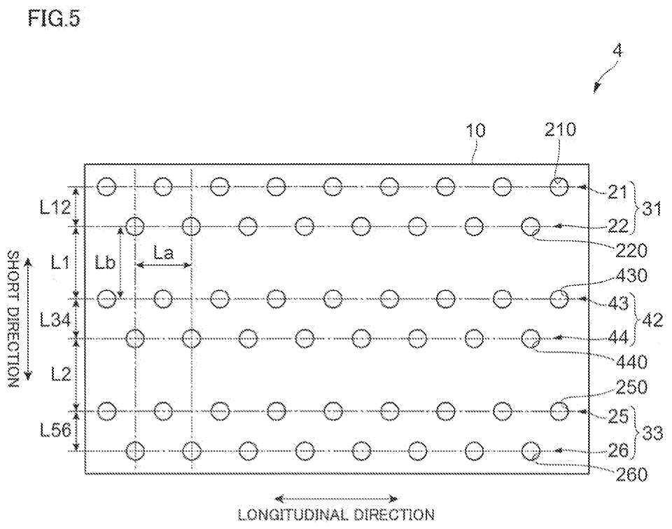

FIG. 5 is a plan view of a cultivation panel 4 related to the second exemplary embodiment.

The cultivation panel 4 related to the second exemplary embodiment is different from the cultivation panel 1 related to the first exemplary embodiment in the positions of the through holes 20 formed in the panel main body 10. Hereinafter, the points of the cultivation panel 4 different from the cultivation panel 1 will be described. In the cultivation panel 4 and the cultivation panel 1, components having the same functions will be assigned with the same reference signs, and detailed descriptions thereof will be omitted.

The cultivation panel 4 includes a first hole group 31 and a third hole group 33. In addition, the cultivation panel 4 includes a second hole group 42 corresponding to the second hole group 32.

The second hole group 42 includes a third hole row 43 in which plural through holes 430 are arranged in line in the longitudinal direction and a fourth hole row 44 provided at a position of a distance L34 in the short direction from the third hole row 43, in which plural through holes 440 are arranged in line in the longitudinal direction.

The second hole group 42 is in the same shape with the first hole group 31 and the third hole group 33. In other words, the cultivation panel 4 includes the first hole row 21, the second hole row 22 and the third hole row 43 arranged in line in this order in the short direction, and positions of the through holes 220 in the second hole row 22 and positions of the through holes 430 in the third hole row 43 do not overlap each other. Then, each of two adjacent through holes 220 in the second hole row 22 and one through hole 430 in the third hole row 43 is disposed to serve as a vertex of an isosceles triangle.

Moreover, the cultivation panel 4 includes a sixth hole row 26, a fifth hole row 25 and the fourth hole row 44 arranged in line in this order in the short direction, and positions of the through holes 250 in the fifth hole row 25 and positions of the through holes 440 in the fourth hole row 44 do not overlap each other. Then, each of two adjacent through holes 250 in the fifth hole row 25 and one through hole 440 in the fourth hole row 44 is disposed to serve as a vertex of an isosceles triangle.

In the cultivation panel 4 configured as described above, also, similar to the cultivation panel 1, each hole group (the first hole group 31, the second hole group 42 and the third hole group 33) is constituted by two hole rows, and the distance Lb in the short direction between the adjacent hole groups (between the first hole group 31 and the second hole group 42, and between the second hole group 42 and the third hole group 33) is set larger than the distance La between the adjacent through holes 20 in each hole group.

Therefore, according to the cultivation panel 4, even though plants are grown in all of the plural through holes 20, it is possible to eliminate variations to be caused in size of the plants while securing productivity similar to the productivity in using the panel related to the comparative example.

Note that, in the cultivation panel 4, similar to the cultivation panel 1, the distance between the adjacent hole groups (between the first hole group 31 and the second hole group 42, and between the second hole group 42 and the third hole group 33) in the short direction is referred to as the distance Lb, which is, however, not particularly limited. For example, the shortest distance between the through holes 20 in the adjacent hole groups (for example, the shortest distance between the through holes 220 and the through holes 430) may be referred to as the distance Lb. This makes it possible to reduce the distance in the short direction between the adjacent hole groups while keeping distances among the plants.

### Third Exemplary Embodiment

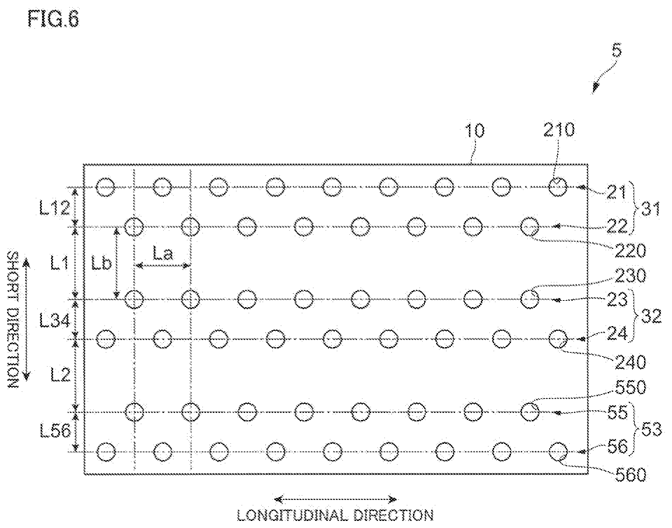

FIG. 6 is a plan view of a cultivation panel 5 related to the third exemplary embodiment.

The cultivation panel 5 related to the third exemplary embodiment is different from the cultivation panel 1 related to the first exemplary embodiment in the positions of the through holes 20. Hereinafter, the points of the cultivation panel 5 different from the cultivation panel 1 will be described. In the cultivation panel 5 and the cultivation panel 1, components having the same functions will be assigned with the same reference signs, and detailed descriptions thereof will be omitted.

The cultivation panel 5 includes a first hole group 31 and a second hole group 32. In addition, the cultivation panel 5 includes a third hole group 53 corresponding to the third hole group 33.

The third hole group 53 includes a fifth hole row 55 in which plural through holes 530 are arranged in line in the longitudinal direction and a sixth hole row 56 provided at a position of a distance L56 in the short direction from the fifth hole row 55, in which plural through holes 560 are arranged in line in the longitudinal direction.

Then, the third hole group 53 is in a same shape with the second hole group 32 and is in a symmetrical shape with the first hole group 31. In other words, the cultivation panel 5 includes the sixth hole row 56, the fifth hole row 55 and the fourth hole row 24 arranged in line in this order in the short direction, and positions of the through holes 560 in the sixth hole row 56 and positions of the through holes 240 in the fourth hole row 24 overlap each other. Then, each of two adjacent through holes 550 in the fifth hole row 55 and one through hole 240 in the fourth hole row 24 is disposed to serve as a vertex of an isosceles triangle.

In the cultivation panel 5 configured as described above, also, similar to the cultivation panel 1, each hole group (the first hole group 31, the second hole group 32 and the third hole group 53) is constituted by two hole rows, and the distance Lb in the short direction between the adjacent hole groups (between the first hole group 31 and the second hole group 32, and between the second hole group 32 and the third hole group 53) is set larger than the distance La between the adjacent through holes 20 in each hole group.

Therefore, according to the cultivation panel 5, even though plants are grown in all of the plural through holes 20, it is possible to eliminate variations to be caused in size of the plants while securing productivity similar to the productivity in using the panel related to the comparative example.

Note that, in the cultivation panel 5, similar to the cultivation panel 1, the distance between the adjacent hole groups (between the first hole group 31 and the second hole group 32, and between the second hole group 32 and the third hole group 53) in the short direction is referred to as the distance Lb, which is, however, not particularly limited. For example, the shortest distance between the through holes 20 in the adjacent hole groups (for example, the shortest distance between the through holes 550 and the through holes 240) may be referred to as the distance Lb. This makes it possible to reduce the distance in the short direction between the adjacent hole groups while keeping distances among the plants.

### <Regarding Plant Cultivation Device>

Hereinafter, description will be given of a plant cultivation device 100 suitable to cultivate plants by use of the cultivation panel 1 related to the first exemplary embodiment, the cultivation panel 4 related to the second exemplary embodiment or the cultivation panel 5 related to the third exemplary embodiment. The plant cultivation device 100 is installed in, for example, a closed plant factory. The plant cultivation device 100 is used for cultivating, for example, lettuces such as a leaf lettuce. Note that, in the following description, the plant cultivation device 100 includes the cultivation panel 1 related to the first exemplary embodiment; the same is true for the cultivation panels 4 and 5, and therefore, detailed description thereof will be omitted.

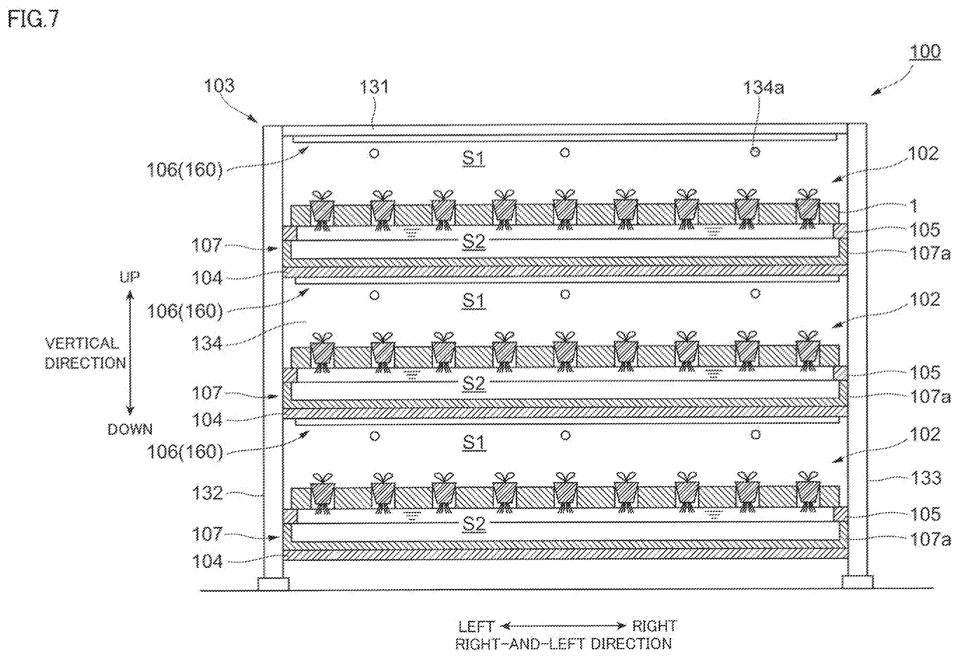

FIG. 7 is a diagram showing an example of a schematic configuration of the plant cultivation device 100, the plant cultivation device 100 being viewed from the front. In FIG. 7, a front wall of a housing 103, which will be described later, is omitted.

The plant cultivation device 100 is a so-called multistage device in which an outer shape is a rectangular-parallelepiped shape and plural (three in the example shown in FIG. 7) cultivation shelves 102 for cultivating plants are formed in the vertical direction. In the plant cultivation device 100, the cultivation panel 1 is placed on each of the cultivation shelves 102, and the plants are cultivated in the cultivation panel 1.

The plant cultivation device 100 includes: the housing 103 collectively enclosing the plural cultivation shelves 102; base plates 104 partitioning space in the housing 103 for the plural cultivation shelves 102 and constituting bottom surfaces of the respective cultivation shelves 102; and placement parts 105 on each of which the cultivation panel 1 is placed.

Moreover, the plant cultivation device 100 includes: light irradiators 106 irradiating the respective cultivation panels 1 placed on the placement parts 105 with light; water suppliers 107 supplying the plants cultivated by use of the cultivation panels 1 with nutrient solution; and a blower (not shown) for sending air currents to the respective cultivation shelves 102.

The housing 103 includes: an upper wall 131 positioned above the cultivation shelves 102; a left wall 132 and a right wall 133 positioned on the left and right sides of the cultivation shelves 102, respectively; a rear wall 134 positioned on the rear side of the cultivation shelves 102; and a front wall (not shown) positioned on the front side of the cultivation shelves 102. The front wall can be opened and closed with respect to the upper wall 131, the left wall 132 and the right wall 133; by opening the front wall, it becomes possible to carry out operations, such as setting the cultivation panels 1 to the respective cultivation shelves 102.

In the rear wall 134 of the housing 103, ventilation ports 134a for supplying the air currents generated by the blower to the cultivation shelves 102 are formed. Each ventilation port 134a is provided at a position facing a growth region S1, which will be described later, of the cultivation shelf 102. In this example, there are provided a total of nine ventilation ports 134a: three in the right-and-left direction and three in the vertical direction in accordance with the positions of the cultivation panels 1 placed on the cultivation shelves 102.

In addition, in the front wall of the housing 103, exhaust ports (not shown) for exhausting the air currents passed through the growth regions S1 via the ventilation ports 134a to the outside of the plant cultivation device 100 are formed. Each exhaust port is provided at a position facing the growth region S1 of the cultivation shelf 102. In this example, there are provided a total of nine exhaust ports: three in the right-and left direction and three in the vertical direction in accordance with the positions of the cultivation panels 1 placed on the cultivation shelves 102.

The base plates 104 partition the space enclosed by the upper wall 131, the left wall 132, the right wall 133, the rear wall 134 and the front wall of the housing 103 for the plural cultivation shelves 102 and constitute the bottom surfaces of the respective cultivation shelves 102. In the configuration of FIG. 7, three base plates 103 are provided in the vertical direction with gaps. Therefore, the plant cultivation device 100 is divided into three cultivation shelves 102 in the vertical direction by the base plates 104.

The placement part 105 protrudes inward from the left wall 132, the right wall 133, the rear wall 134 and the front wall. The placement part 105 divides the space in each cultivation shelf 102 into the growth region S1 positioned above the placement part 105, where the plants cultivated by the cultivation panel 1 are grown and a water supply region S2 positioned below the cultivation panel 1, where the nutrient solution is supplied from the water supplier 107 to the plants cultivated by the cultivation panel 1.

Each of the light irradiators 106 is provided on a surface of each of the upper wall 131 and the base plates 104, the surface facing the growth region S1 in the corresponding cultivation shelf 102, in other words, on a surface parallel to the cultivation panel 1, to thereby irradiate the plants with light necessary for growing thereof. The light irradiator 106 can be, as an example, a device that emits light by use of LEDs (Light Emitting Diodes). Each of the light irradiators 106 is in a straight tubular shape extending in the right-and-left direction, and is provided with plural (for example, five) LED lamps arranged in the back-and-forth direction at predetermined regular intervals in parallel with one another.

Each of the water suppliers 107 has a nutrient solution tank 107a storing the nutrient solution. The nutrient solution tank 107a is placed on the base plate 104 in the water supply region S2 of each cultivation shelf 102.

The blower includes plural fans (not shown) attached to the respective ventilation ports 134a and rotated to send the air currents to the growth regions S1 of the respective cultivation shelves 102. The blower rotates the fans at a predetermined time to send air to the growth regions S1 of the respective cultivation shelves 102.

### <Regarding Method for Cultivating Plants>

A method for cultivating plants by the above-described plant cultivation device 100 includes a step of placing the cultivation panels 1 on the placement parts 105 of the plant cultivation device 100 to install the cultivation panels 1 and a step of setting the plants in the through holes 20 formed in the cultivation panels 1. Note that it does not matter either the step of installing the cultivation panels 1 or the step of setting the plants is earlier in the order. In other words, it may be acceptable to set (insert) the plants into the through holes 20 formed in the cultivation panels 1 after the cultivation panels 1 have been placed on the placement parts 105 of the plant cultivation device 100, or it may also be acceptable to place the cultivation panels 1, in which the plants have been set, on the placement parts 105 of the plant cultivation device 100 after the plants have been set (inserted) into the through holes 20 formed in the cultivation panels 1.

Then, the plants cultivated by the plant cultivation device 100 can be, as an example, leaf lettuces. In the case where the leaf lettuces are cultivated by the plant cultivation device 100, the leaves of the leaf lettuces are likely to laterally (in the right-and-left direction or the back-and-forth direction) spread, and thereby the leaf lettuces are likely to mutually shield light or air currents. However, in the growth by use of the cultivation panel 1, not many leaf lettuces are grown around one leaf lettuce and the leaf lettuces are less likely to mutually shield the light or air currents; therefore, the leaf lettuces tend to grow larger.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cultivation panel comprising:
a panel main body including: a first hole group constituted by a first hole row having a plurality of holes arranged in line in a first direction and a second hole row provided at a position away from the first hole row in a second direction intersecting the first direction, the second hole row having a plurality of holes arranged in line in the first direction; and a third hole row having a plurality of holes arranged in line in the first direction, a first distance between one hole among the plurality of holes in the third hole row and one hole among the plurality of holes in the second hole row of the first hole group being larger than a second distance between adjacent holes in the second hole row.

2. The cultivation panel according to claim 1, wherein positions of the holes in the first hole row and positions of the holes in the second hole row do not overlap each other in the first direction.

3. The cultivation panel according to claim 2, wherein two adjacent holes in one of the first hole row and the second hole row and one hole in the other one of the first hole row and the second hole row are disposed to serve as respective vertexes of an equilateral triangle.

4. The cultivation panel according to claim 1, wherein
the first hole row, the second hole row and the third hole row are arranged in this order in the second direction, and
positions of the holes in the second hole row and positions of the holes in the third hole row do not overlap each other in the first direction.

5. The cultivation panel according to claim 1, wherein two adjacent holes in the second hole row and one hole in the third hole row are disposed to serve as respective vertexes of an isosceles triangle.

6. The cultivation panel according to claim 1, wherein
the cultivation panel is in a shape of a rectangle when viewed in a centerline direction of each of the plurality of holes, and
the first direction is a longitudinal direction of the rectangle and the second direction is a short direction of the rectangle.

7. A cultivation panel comprising:
a panel main body including: a first hole group constituted by a first hole row having a plurality of holes arranged in line in a first direction and a second hole row provided at a position away from the first hole row in a second direction intersecting the first direction, the second hole row having a plurality of holes arranged in line in the first direction; and a second hole group constituted by a third hole row having a plurality of holes arranged in line in the first direction and a fourth hole row provided at a position away from the third hole row in the second direction, the fourth hole row having a plurality of holes arranged in line in the first direction, wherein
the first hole group and the second hole group are separated in the second direction to make a distance between a hole included in the second hole row of the first hole group and a hole included in the third hole row of the second hole group larger than a distance between adjacent holes in the second hole row of the first hole group.

8. A method for cultivating a plant, the method comprising:
installing a cultivation panel comprising a panel main body including: a first hole group constituted by a first hole row having a plurality of holes arranged in line in a first direction and a second hole row provided at a position away from the first hole row in a second direction intersecting the first direction, the second hole row having a plurality of holes arranged in line in the first direction; and a third hole row having a plurality of holes arranged in line in the first direction, a first distance between one hole among the plurality of holes in the third hole row and one hole among the plurality of holes in the second hole row of the first hole group being larger than a second distance between adjacent holes in the second hole row; and
setting a plant in each of the holes formed in the cultivation panel.

9. The method for cultivating a plant according to claim 8, wherein,
in installing the cultivation panel, the cultivation panel is installed in a plant cultivation device provided in a closed plant factory, and,
in setting the plant, a leaf lettuce is set in each of the holes formed in the cultivation panel.
